(19) United States
(12) Patent Application Publication
(10) Pub. No.: US 2011/0248679 A1
(43) Pub. Date: Oct. 13, 2011

(54) Actively Rapid Battery Voltage Balancing System

(76) Inventors: Jenn-Yang Tien, Hsinchu City (TW); Ian-Wu Hong, Hsinchu City (TW)

(21) Appl. No.: 12/758,012

(22) Filed: Apr. 11, 2010

(51) Int. Cl. H02J 7/00

(52) U.S. Cl. 320/120

(57) ABSTRACT

The present invention provides an actively rapid battery voltage balancing system which includes a power converter, a switch, a voltage balancing multiplexer, a voltage measurement multiplexer, a voltage sensor, a microprocessor, and a series connected battery pack. By the application of the above components, the balancing voltage conditions of each battery cell in a series connected battery pack can be actively monitored and estimated. While in the charge or discharge period, if a battery cell in the series connected battery pack is determined to be an unbalanced cell, the voltage balancing process can be carried out promptly. Less component is required to fulfill the purpose of the cell voltage balance in the present invention.

### BACKGROUND OF THE INVENTION

(a) Field of the Invention

This invention relates to an actively rapid battery voltage balancing system, and inure particularly to the voltage balancing for series connected battery cells in a battery pack. For instance, the functions of fast charging and heavy loading are required for a series connected heavy duty battery pack. Under the condition of large current charging or discharging, the voltage of each battery cell in a series connected battery pack can be actively selected and monitored. The most unbalanced battery cell will be identified and a voltage balancing procedure will proceed to this battery cell. In the system of present invention a multiplexer is applied to effectively reduce the components required for voltage balancing implementation.

(b) Description of the Prior Art

Unbalancing charging or discharging problems occur in series connected battery cells are widely known. Formerly, there were energy consuming and non-consuming ways to achieve the battery cell balancing for series connected battery cells, such as designs in Taiwan patent I280721, M321172 and United States Patent US005479083, US005982143, US006356055 and US007049791 etc. A large number of balancing components are required in the conventional ways of balancing circuit and cannot actively locate an unbalanced battery and rapidly proceed to a voltage balancing process for the battery.

In view of the foregoing, an objective of this invention is to provide an actively and rapidly battery voltage balancing system to improve the battery cell balancing design.

### SUMMARY OF THE INVENTION

The main purpose of the present invention is to provide an actively rapid battery voltage balancing system which comprising a power converter, a switch, a voltage balancing multiplexer, a voltage measurement multiplexer, a voltage sensor, a microprocessor and a series connected battery pack. During large current charge or discharge period, aimed to fulfill the rapid charge and heavy duty loading requirement for each battery cell in the series connected battery pack, the battery cell voltages are actively monitored and estimated to judge the balance condition and a voltage balancing process is rapidly proceeded while needed.

### BRIEF DESCRIPTION OF THE DRAWINGS

FIG. 1 is the system circuit embodiment diagram of the present invention.

FIG. 2 is another system circuit embodiment diagram of the present invention.

### DETAILED DESCRIPTION OF THE PREFERRED EMBODIMENTS

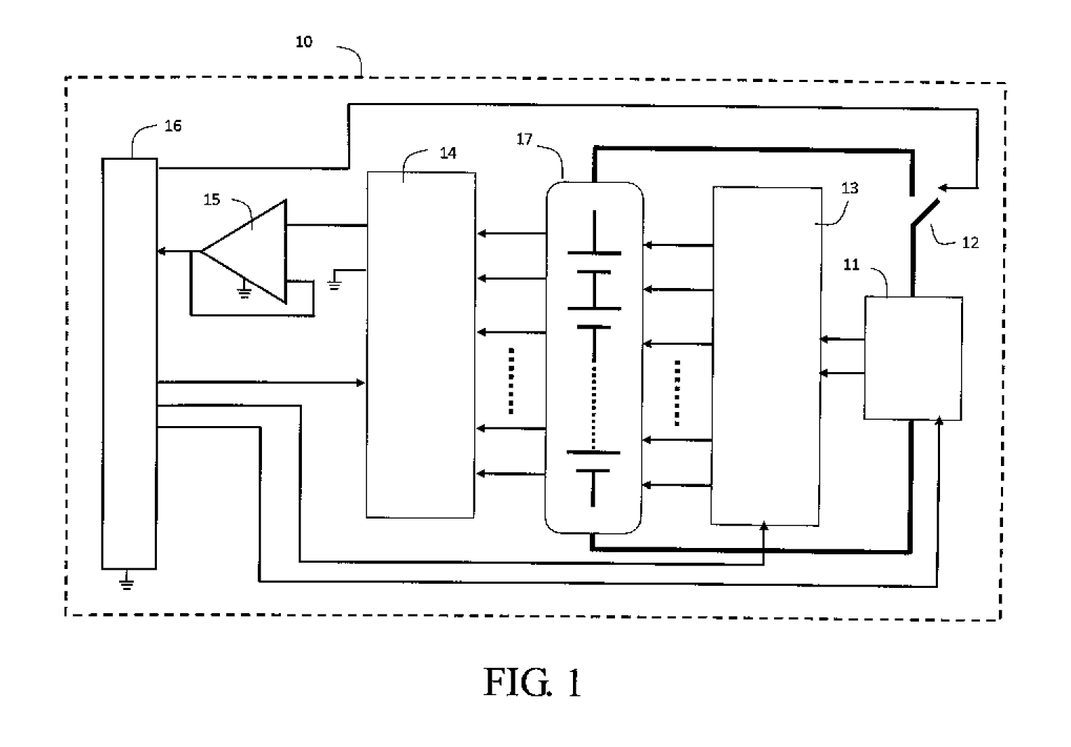

Please refer to FIG. 1 for the circuit diagram. The actively rapid battery voltage balancing system (10) of present invention is composed of a power converter (11), a switch (12), a voltage balancing multiplexer (13), a voltage measurement multiplexer (14), a voltage sensor (15), a microprocessor (16) and a series connected battery pack (17).

In which, the power converter (11) is a device of DC to DC electric power converter. The input end of the power converter (11) is connected to the end that provides the overall output voltage of the series connected battery pack (17). This output end of the power converter (11) is an isolated power output end having two terminals for positive and negative electrodes. The power converter (11) is also connected to the microprocessor (16) and accepts the commands come from the microprocessor (16) to control and tune the range of its output power.

The switch (12) is a circuit installed between the power converter (11) and the series connected battery pack (17) and is connected to the microprocessor (16) to accept the commands come from the microprocessor (16) to turn on or turn off the switch (12) circuit.

The voltage balancing multiplexer (13) is a multiple channel to 2-channel multiplexer. The input port of this multiplexer has two contacts to connect to the output port of the power converter (11). The output ports of the voltage balancing multiplexer (13) are connected to the corresponding terminals of each battery cell's positive electrode and negative electrode terminals in the series connected battery pack (17). The voltage balancing multiplexer (13) is also connected to the microprocessor (16) and accepts the commands come from the microprocessor (16) to process the corresponding connection switching between the input terminals and output terminals to locate the one specific battery cell in the series connected battery pack (17) to proceed with the voltage balancing process for the chosen one battery cell. The main components to be chosen as switching components in the voltage balancing multiplexer (13) are as relays or transistors.

The voltage measurement multiplexer (14) is a multiple channel to 2-channel multiplexer. The input ports of this multiplexer are connected to the corresponding terminals of each battery cell's positive electrode and negative electrode terminals in the series connected battery pack (17). The output port of the voltage measurement multiplexer (14) has two contact terminals One of the two terminals is connect to a ground end and the other one to the input end of the voltage sensor (15). The voltage measurement multiplexer (14) is also connected to the microprocessor (16) and accepts the commands come from the microprocessor (16) to process the corresponding connection switching between the input and of the voltage measurement multiplexer (14) to monitor the voltage balancing status for the chosen one battery cell in the series connected battery pack (17). The main components to be chosen as switching components in the voltage measurement multiplexer (14) are as relays or transistors.

The output terminal of the voltage sensor (15) is connected to the microprocessor (16). Via the channel selection of the voltage measurement multiplexer (14) the voltage of one of the battery cells in the series connected battery pack (17) can be transported by the voltage sensor (15) to the microprocessor (16) to estimate its balancing status.

The microprocessor (16) is mainly estimates the voltage status of each battery cell transported by the voltage sensor (15) and determines the voltage balancing processes according to the monitored voltage statuses. Meanwhile the microprocessor (16) sends commands to each related switching component to select one of the battery cells in the series connected battery pack (17) to be monitored and determines the voltage balancing processes. The microprocessor (16) and the voltage sensor (15) are common grounded and the ground end is an isolated ground end which provides a right measurement of the terminal voltage for the battery cell.

The series connected battery pack (17) is comprised of multiple battery cells which are series connected. The positive electrode and the negative electrode of each battery cell are respectively connected to the corresponding output terminals of the voltage balancing multiplexer (13) and meanwhile connected to the corresponding input terminals of the voltage measurement multiplexer (14).

While the series connected battery pack (17) is under the charge or discharge period, the microprocessor (16) can actively and continually monitor voltage statuses of each battery cell in the series connected battery pack (17) via the voltage sensor (15) and the voltage measurement multiplexer (14). When the voltage difference (ΔV) between the highest voltage battery cell and the lowest voltage battery cell is lower than the preset threshold voltage (ΔV), each battery cell in the series connected battery pack (17) is in the balanced condition and the battery voltage balancing process is unnecessary, meanwhile, the switch (12) is commanded to cut off the power supply circuit between the power converter (11) and the series connected battery pack (17) to save the power consumption.

On the other hand, when the voltage difference (ΔV) between the highest voltage battery cell and the lowest voltage battery cell exceeds the preset threshold voltage (ΔV), the microprocessor (16) commands the voltage balancing multiplexer (13) to switch its output terminals to the corresponding lowest voltage battery cell's terminals and then establish a channel to connect the two terminals of the chosen one battery cell with lowest voltage to the output terminals of the power converter (11). Meanwhile, the microprocessor (16) commands the switch (12) to turn on the power source circuit between the power converter (11) and the series connected battery pack (17) and they the power converter (11) begins to charge the chosen on lowest voltage battery cell till the voltage difference (ΔV) between the chosen one battery and the highest voltage one lower than the threshold voltage (ΔV).

During the voltage balance processing period the microprocessor (16) continually monitor the voltage of each battery cell in the series connected battery pack (17). The charge current of the power converter (11) can be adjusted in accordance with the required balance speed. A higher output current is set to accommodate to a quicker balancing requirement.

While the series connected battery pack (17) is under a standby period, the charge or discharge current is not required for the series connected battery pack (17) and there is no current flow in or out of the pack. The voltage balancing process will not be executed under this condition and the switch (12) is commanded to cut off the power supply source to save the power consumption.

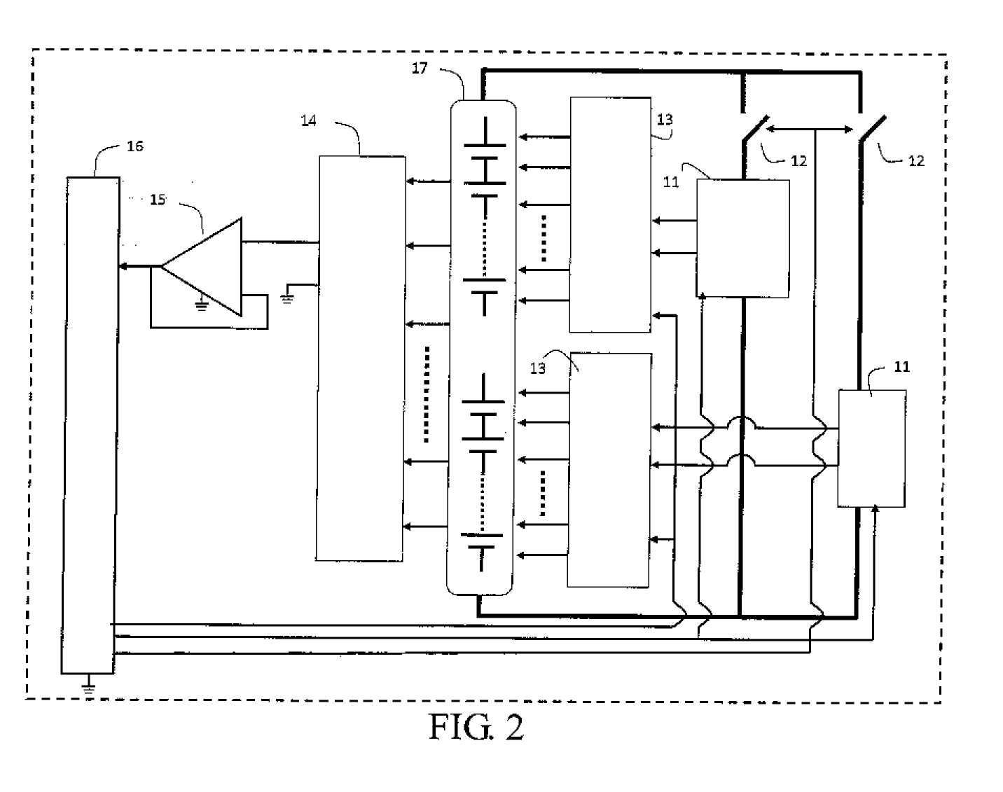

The number of the battery cell in a series connected battery pack (17) is increased due to the higher voltage requirement for a practical application. In order to accelerate the balance speed for a series connected battery pack (17), the battery cells can be divided into several groups. Each group forms a series connected battery pack (17) and the corresponding components are provided to conduct the voltage balancing process respectively. Please refer to the FIG. 2 for details.

The charging or discharging process of a series connected battery pack of 20 battery cells of LiFePO4 is taken for a example to illustrate the embodiment of the present invention.

In the battery pack, each LiFePO4 battery cell's capacity is specified as 3.2V/10 Ah. To speed up the voltage balancing, the 20 series connected LiFePO4 battery cells are divided into two groups. Each group has 10 LiEePO4 battery cells which are series connected to be a series connected battery pack (17) and each group is provided with a power converter (11) with isolated output and a voltage balancing multiplexer (13).

If more groups of the series connected battery pack (17) is required in accordance with the practical condition for a multiple series connected battery cells, the grouping method is the same as mentioned in the above and multiple power converters (11) and multiple voltage balancing multiplexers (13) are to be added.

The power source input voltage of each of such power converter (11) mentioned above is the overall voltage of 20 series connected LiFePO4 battery cells. The output voltage of such power converter (11) is suitable for charging one LiFePO4 battery cell and its output current can be adjusted to accommodate to the quicker balancing requirement.

Given that the overall voltage of the 20 series connected LiFePO4 battery pack is 64V and a battery cell with lowest voltage of 3.1V and a battery cell with highest voltage of 3.3V are existing in one of the series connected battery packs (17). The voltage difference (ΔV) of the two battery cells is 0.2V and exceeds the preset threshold voltage of 0.1V, hence the voltage balancing process will be commenced.

The microprocessor (16) commands the voltage balancing multiplexer (13) to select a channel for the battery cell with lowest voltage. The output terminals of the power converter (11) are then connected to the terminals of the battery cell with lowest voltage via the voltage balancing multiplexer (13). The microprocessor (16) also commands the power converter (11) to set its output voltage and current to be 3.65V/8 A, meanwhile, the microprocessor (16) commands the switch (12) to turn on the power source circuit between the power converter (11) and the series connected battery pack (17) and then commences the voltage balancing process. The power converter (11) then begins to charge the battery cell with lowest voltage with fast charging mode.

When the battery cell with lowest voltage is being charged to a voltage that is less than the preset 0.1 V threshold voltage differ from the voltage of the battery cell with highest voltage, the microprocessor (16) will commands the switch (12) to cut off the power source circuit between the power converter (11) and the series connected battery pack (17) and then stop the charging process for that battery cell with lowest voltage.

During the period of voltage balancing process, the microprocessor (16) still continually monitor the voltage of each battery cell in the series connected battery packs (17). After completed a voltage balancing process for a battery cell, the microprocessor (16) keep on finding out the battery cells with lowest and highest voltage and estimate the voltage balancing condition to determine the commencement of the voltage balancing processes.

When the voltage difference (ΔV) among all the battery cells in one series connected battery pack (17) is less than the preset 0.1V threshold voltage, then that one series connected battery pack (17) will not execute the voltage balancing process and the switch (12) will cut off the power source circuit of the relating power converter (11) to save the power consumption. Meanwhile, the microprocessor (16) still keeps on monitoring the voltage conditions of each battery cell in the series connected battery pack (17).

The multiplexers are appropriately applied in this application so that only two set of power converters (11) are required for the voltage balancing process. The components required for the voltage balancing process are tremendously reduced.

What is claimed is:

1. An actively rapid battery voltage balancing system, which comprising:
a power converter which input power terminal is connected to the terminal provides overall voltage of the series connected battery pack and this power converter is also connected to the microprocessor;
a switch which is a circuit installed between the power converter and the series connected battery pack and is also connected to the microprocessor;
a voltage balancing multiplexer which input port has two terminals connected to output terminals of power converter and which output ports are connect to the corresponding positive electrode terminal and negative electrode terminal of each battery cell in the series connected battery pack and which also connected to the microprocessor;
a voltage measurement multiplexer which input ports are connect: to the corresponding positive electrode terminal and negative electrode terminal of each battery cell in the series connected battery pack and which output ports has two terminals that one terminal connected to the ground end and the other one terminal connected to the input terminal of the voltage sensor and which also connected to the microprocessor;
a voltage sensor which output terminal connected to the microprocessor to transport the monitored voltage of each battery cell in the series connected battery pack to the microprocessor;
a microprocessor which estimates the conditions of voltage of each battery cell transported via the voltage sensor and which sends commands to the related components to select a battery cell in the series connected battery pack to conduct the voltage monitoring and/or conduct the voltage balance processing;
a series connected battery pack which is formed by series connection of plural battery cells;
by the application of the above components, the cell voltage monitoring and the voltage balancing process are implemented for each battery cell in a series connected battery pack.

2. The actively rapid battery voltage balancing system as claimed in claim 1, wherein the power converter is a kind of Dc to DC power converter.

3. The actively rapid battery voltage balancing system as claimed in claim 1, wherein the output terminal of the power converter is an isolated power output terminal.

4. The actively rapid battery voltage balancing system as claimed in claim 1, wherein the switch, when bringing a voltage balance process into practice, can accept the commands sent from microprocessor to turn on the circuit between the series connected battery pack and the power converter to supply the overall voltage of the series connected battery pack to the input terminal of the power converter; while a voltage balance process is unnecessary, the circuit between the series connected battery pack and the power converter will be cut off to save the power consumption.

5. The actively rapid battery voltage balancing system as claimed in claim 1, wherein the switching components in the voltage balancing multiplexer can be composed mainly of relays or transistors.

6. The actively rapid battery voltage balancing system as claimed in claim 1, wherein the switching components in the voltage measurement multiplexer can be composed mainly of relays or transistors.

7. The actively rapid battery voltage balancing system as claimed in claim 1, wherein the voltage balancing multiplexer can accept the commands sent from the microprocessor to switch the corresponding channel between the input port and the output port so that the voltage balancing process can be carried out for each chosen battery cell in the series connected battery pack.

8. The actively rapid battery voltage balancing system as claimed in claim 1, wherein the voltage measurement multiplexer can accept the commands sent from the microprocessor to switch the corresponding channel between the input port and the input terminal of the voltage sensor so that the voltage conditions of each chosen battery cell in the series connected battery pack can be monitored for balancing estimation.

9. The actively rapid battery voltage balancing system as claimed in claim 1, wherein the ground end of the microprocessor is common grounded with the output end of the voltage sensor and this ground end is an isolated ground end for correct battery terminal voltage measurements.
